(19) United States
(12) Patent Application Publication
(10) Pub. No.: US 2008/0145593 A1
(43) Pub. Date: Jun. 19, 2008

(54) Treading mat for vehicle internal floor

(76) Inventor: Fu Pao Tsai, Chia-Yi Hsien (TW)

Correspondence Address: PHILLIP LIU, 6980, WHITEOAK DR., RICHMOND, BC, V7EAZ9, omitted

(21) Appl. No.: 12/071,724

(22) Filed: Feb. 26, 2008

Related U.S. Application Data
(63) Continuation-in-part of application No. 11/253,676, filed on Oct. 20, 2005.

(51) Int. Cl. B32B 33/00

(52) U.S. Cl. 428/91

(57) ABSTRACT

The present invention is an “improved treading mat for vehicle internal floor”, which mainly comprises: a mat body including an elastic shag layer, a meshed network and a Velcro fillet, wherein, said elastic shag layer being built into entwined manner with numerous pores of various size being formed therein; said meshed network being securely stuck at the bottom of the elastic shag layer and built into a laminated slab with multitudinous meshes; said Velcro fillet being configured around the common marginal rim of said elastic shag layer with meshed network; and a sole layer including a spiked bolster, an anti-slip studs, a Velcro fillet and a flexible frame, wherein, said spiked bolster having plural spikes evenly spread on the upper side thereof; said anti-slip studs being evenly spread at the bottom side thereof; said Velcro fillet being securely sewn around the marginal rim thereof; said flexible frame being disposed between the sole layer marginal rim and Velcro fillet. By means of the contrivance of the meshed network of the mat body, the elastic shag in the elastic shag layer can be effectively firmly stuck therein in reinforced manner to avoid being torn into fall off due to deformation and fracture and achieve the effect in thoroughly cleansing and washing the dust, dirt and grit from easily sticking assembly and separating disassembly.

### RELATED APPLICATIONS

This is a Continuation-In-Part patent application of applicant's earlier non-provisional application of Ser. No. 11/253,676, filed on Oct. 20, 2005.

### DESCRIPTION

### Background of the Invention

1. Technical Field

The present invention is an “improved treading mat for vehicle internal floor” particularly for one can avoid the elastic shag form being torn to fall off the mat body due to deformation and fracture and achieve the effect in thoroughly cleansing and washing the dust, dirt and grit from easily sticking assembly and separating disassembly.

2. Prior Arts

Please refer to FIG. 1, which is the cross section combinational view of the conventional vehicle mat. The conventional treading mat for vehicle internal floor comprises a mat body 10 and a sole layer 20, wherein, said mat body 10 is built of curled and crimped elastic shags 101, which is made of polyvinyl chloride (PVC) material in entwined manner with adjacent elastic shags 101 being bonded together consecutively into a laminated slab, so that numerous pores 102 of various size are formed therein; said sole layer 20, which is also made of polyvinyl chloride (PVC) material in solid manner. An upper and a corresponding lower Velcro fillet 103, 201 is configured around the marginal rim of each said mat body 10 and a sole layer 20 respectively for being stuck each other.

When the user steps on the treading mat in the vehicle internal floor, the dust and dirt stuck on the shoe-sole of the user will be wiped or scraped off to fall over the sole layer 20 for collecting thereon via pores 102 among the elastic shags 101. However, after having used such treading mat aforesaid, the applicant of the present invention find that the elastic shags 101 in the mat body 10 will be torn into fall off due to deformation and fracture so that the mat body 10 becomes defectively useless and results in short service lifetime. Moreover, the integral mat body 10 is too supple and soft to be firmly formed in fit with the shape for the internal floor of the vehicle due to no reinforcement contrived so that it becomes easily warped on the edge. In view of these issues and drawbacks aforesaid, the applicant of the present invention is eager to design an improved contrivance to solve them on the basis of many years in the related manufacturing industry. After long term research and study, the innovative contrivance of the present invention is eventually developed successfully.

### SUMMARY OF THE INVENTION

The present invention is an “improved treading mat for vehicle internal floor”, which mainly comprises: a mat body including an elastic shag layer, a meshed network and a Velcro fillet, wherein, said elastic shag layer being built into entwined manner with adjacent elastic shags being bonded together consecutively into a laminated slab, so that numerous pores of various size being formed therein; said meshed network being securely stuck at the bottom of the elastic shag layer and built into a laminated slab with multitudinous meshes of same aperture being evenly spread therein; said Velcro fillet being configured around the common marginal rim of said elastic shag layer with meshed network for firmly sewing together; and a sole layer including a spiked bolster, an anti-slip studs, a Velcro fillet and a flexible frame, wherein, said spiked bolster having plural spikes evenly spread on the upper side thereof; said anti-slip studs being plural boss-like studs evenly spread at the bottom side thereof; said Velcro fillet being securely sewn around the marginal rim thereof; said flexible frame being disposed between the sole layer marginal rim and Velcro fillet.

Accordingly, the object of the present invention is to provide an “improved treading mat for vehicle internal floor” to have features that by the meshed network of the mat body, the elastic shag in the elastic shag layer can be effectively firmly stuck therein in reinforced manner to avoid being torn into fall off due to deformation and fracture so that the service lifetime of treading mat can be effectively prolonged; by the numerous pores among the elastic shag layer and the multitudinous meshes among the meshed network of the mat body, the dust, dirt and grit stuck on the shoe-sole can be effectively wiped and scraped to successfully drop and be collected in sole layer; by the corresponding Velcro fillets on respective mat body and sole layer, the mat body and sole layer can easily torn off to separate the mat body and sole layer away each other for thoroughly cleansing and washing and by the flexible metal flexible frame being disposed between the sole layer marginal rim and Velcro fillet, the treading mat be can properly bent into desired profile in accordance with the topographical contour of the internal floor.

### DETAILED DESCRIPTION OF THE PREFERRED EMBODIMENTS

Please refer to the FIGS. 2 through 5, which are the schematic views of the treading mat for the vehicle internal floor of the present invention. The treading mat comprises:

a mat body 1 including an elastic shag layer 11, a meshed network 12 and a Velcro fillet 13, wherein, said elastic shag layer 11 being built of curled and crimped elastic shags 101 from polyvinyl chloride (PVC) material in entwined manner with adjacent elastic shags 101 being bonded together consecutively into a laminated slab, so that numerous pores 111 of various size being formed therein; said meshed network 12 being securely stuck at the bottom of the elastic shag layer 11 and made of polyvinyl chloride (PVC) blending with dioctyl phthalate (DOP) into a laminated slab with multitudinous meshes 121 of same aperture being evenly spread therein for serving as reinforcement without blocking the dust and dirt dropping through; said Velcro fillet 13 being configured around the common marginal rim of said elastic shag layer 11 with meshed network 12 for firmly sewing together.

a sole layer 2 including a spiked bolster 21, an anti-slip studs 22, a Velcro fillet 13 and a flexible frame 24, wherein, said spiked bolster 21 having plural spikes evenly spread on the upper side thereof for evenly supporting the meshed network 12 over; said anti-slip studs 22 being plural boss-like studs evenly spread at the bottom side thereof for evenly grasping against the vehicle internal floor; said Velcro fillet 23 being securely sewn around the marginal rim thereof for mutually sticking with the corresponding Velcro fillet 13 on the mat body 1; said flexible frame 24 being made of flexible metal such as steel wire and disposed between the sole layer 2 marginal rim and Velcro fillet 23 for framing position and bending enhancement.

Please further refer to the FIG. 5. before bringing the improved treading mat of the present invention to use in the vehicle, the user can properly bend it into desired profile in advance by means of the flexible frame 24 around the marginal rim of the sole layer 2 in accordance with the topographical contour of the internal floor so that the treading mat can closely attach over the vehicle internal floor snugly without improper hump and warp to have integral esthetic appearance as lay it thereon.

Moreover, when the user steps on the improved treading mat in the vehicle internal floor, the dust, dirt and grit stuck on the shoe-sole of the user will be wiped or scraped off to fall over the sole layer 2 for collecting thereon via pores 112 among the elastic shags 101 and the meshes 121 among the meshed network 12 so as to achieve the effect of removing and collecting dust and dirt.

Furthermore, the improved treading mat of the present invention also provides in conveniently cleansing and washing feature by means of the corresponding Velcro fillets 13, 23 on respective mat body 1 and sole layer 2, which being easily torn off to separate the mat body 1 and sole layer 2 away each other for thoroughly cleansing and washing the dust, dirt and grit collected in the sole layer 2.

In conclusion, the present invention has at least following advantages:
1. By means of the contrivance of the numerous pores among the elastic shag layer of the mat body, the dust, dirt and grit stuck on the shoe-sole can be effectively cleared to keep clean in the internal environment of the vehicle.
2. By means of the contrivance of the numerous pores among the elastic shag layer and the multitudinous meshes among the meshed network of the mat body, the dust, dirt and grit stuck on the shoe-sole can be effectively wiped and scraped to successfully drop and be collected in sole layer so as to achieve the removing and collecting effect of the dust, dirt and grit.
3. By means of the contrivance of the meshed network of the mat body, the elastic shag in the elastic shag layer can be effectively firmly stuck therein in reinforced manner to avoid being torn into fall off due to deformation and fracture so that the service lifetime of treading mat can be effectively prolonged.
4. By means of the contrivance of the corresponding Velcro fillets on respective mat body and sole layer, the mat body and sole layer can easily torn off to separate the mat body and sole layer away each other for thoroughly cleansing and washing the dust, dirt and grit collected in the sole layer
5. By means of the contrivance of the spiked bolster having plural spikes evenly spread on upper side of the sole layer, the integral structural and supporting strength of the treading mat can be evenly enhanced efficiently. Besides, the anti-slip and grasping effect against the vehicle internal floor can be efficiently improved so as to closely stick the treading mat over the vehicle floor by the contrivance of the anti-slip studs at the bottom side of the sole layer.
6. By means of the contrivance of the flexible metal flexible frame being disposed between the sole layer marginal rim and Velcro fillet, the user can properly bend the treading mat into desired profile in accordance with the topographical contour of the internal floor so that the treading mat can closely attach over the vehicle internal floor snugly without improper hump and warp.

In summary of the foregoing disclosure, the structure and features of the improved treading mat for the vehicle internal floor in the present invention really has innovative novelty beyond the obviousness of the prior arts with practical usage, which meets the basic criterion of the patentability as it neither being disclosed in the contemporary of the same technical field nor being publicized in any paper. Accordingly, we submit the patent application in accordance with the related patent laws. However, all the disclosure heretofore is only the exemplary preferred embodiments, which are not intended for limiting the scope of the embodiment for the present invention. Therefore, any equivalent change or modification, which does not depart from the nature and spirit of the specifications or claims of the present invention, will be reckoned as in the range of the present invention.

### BRIEF DESCRIPTION OF THE DRAWINGS

FIG. 1 is the cross section combinational view of the conventional vehicle mat.

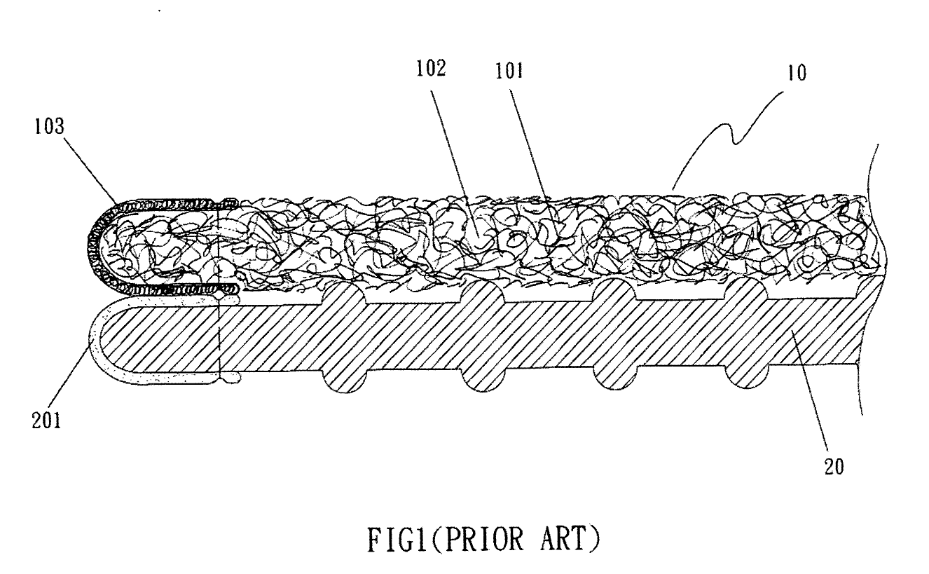

FIG. 2 is the first perspective exploded view for the vehicle mat of the present invention.

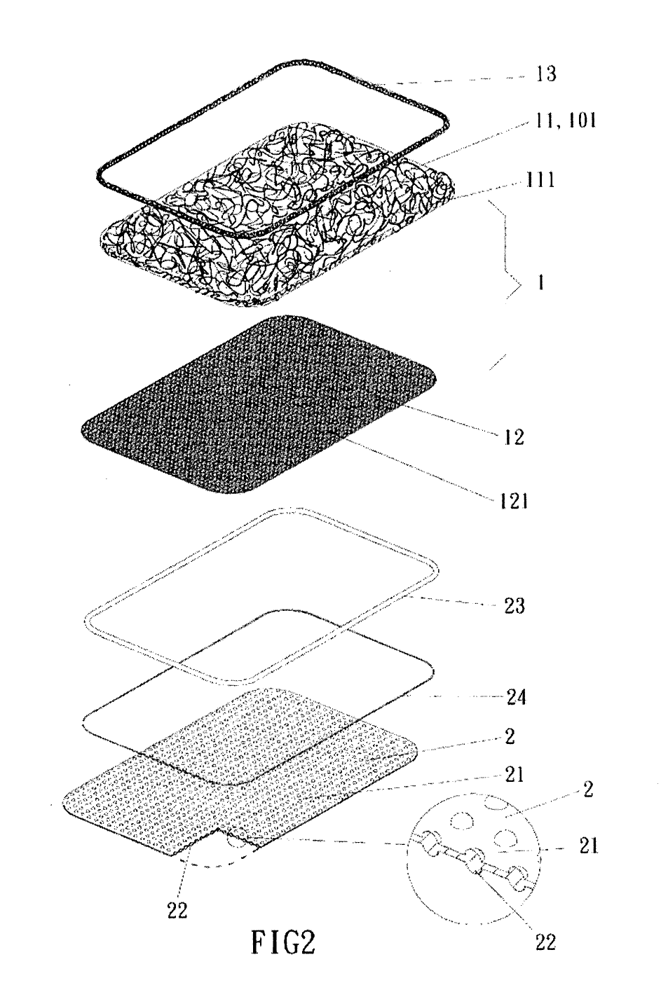

FIG. 3 is the second perspective exploded view for the vehicle mat of the present invention.

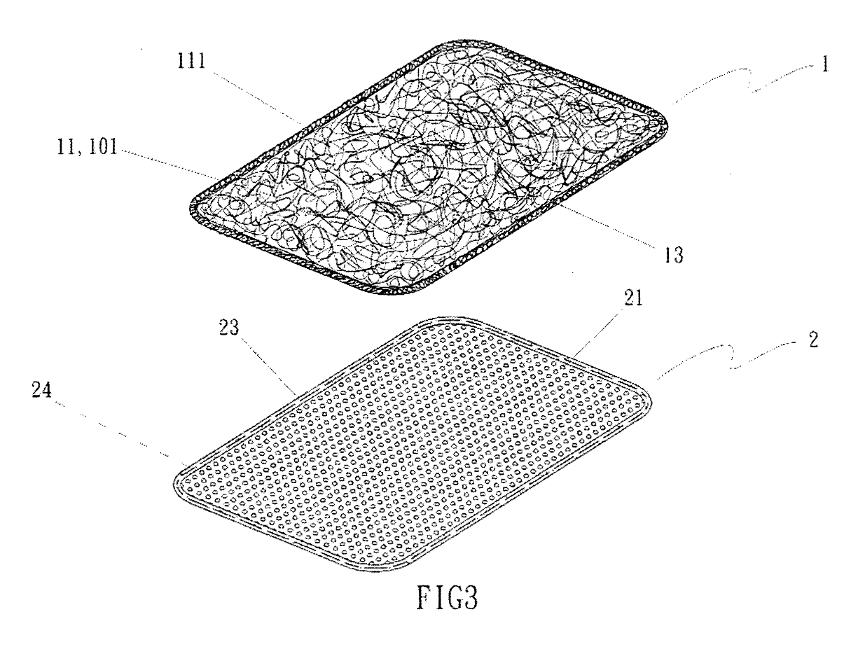

FIG. 4 is the perspective combinational view for the vehicle mat of the present invention.

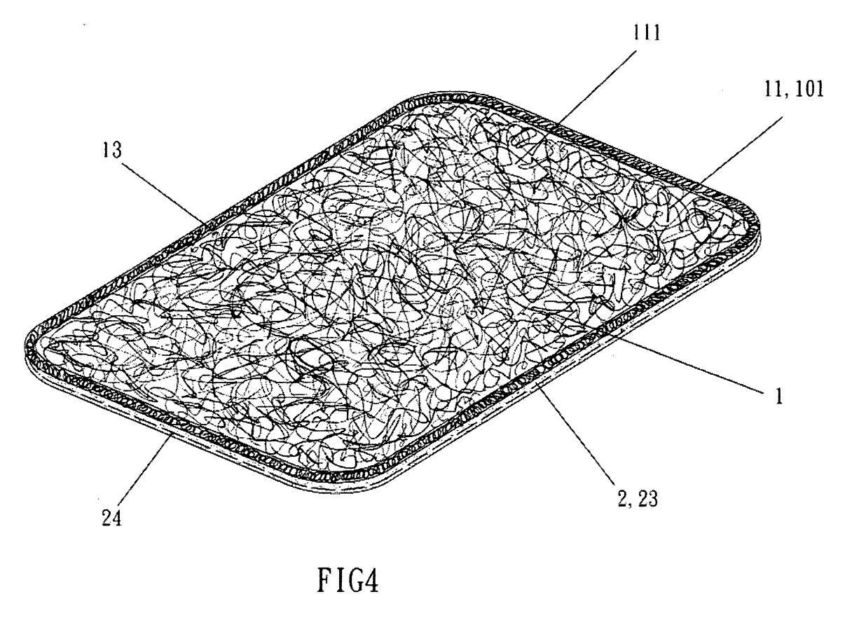

FIG. 5 is the cross section combinational view for the vehicle mat of the present invention.

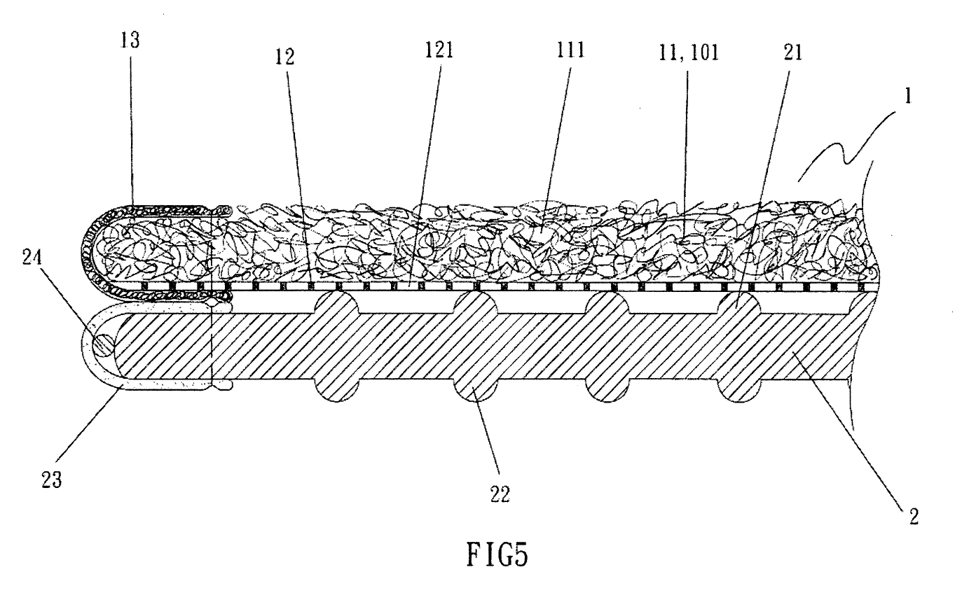

What is claimed is:

1. An “improved treading mat for vehicle internal floor” mainly comprises:
a mat body including an elastic shag layer, a meshed network and a Velcro fillet, wherein, said elastic shag layer being built into entwined manner with adjacent elastic shags being bonded together consecutively into a laminated slab, so that numerous pores of various size being formed therein; said meshed network being securely stuck at the bottom of the elastic shag layer and built into a laminated slab with multitudinous meshes of same aperture being evenly spread therein; said Velcro fillet being configured around the common marginal rim of said elastic shag layer with meshed network for firmly sewing together; and
a sole layer including a spiked bolster, an anti-slip studs, a Velcro fillet and a flexible frame, wherein, said spiked bolster having plural spikes evenly spread on the upper side thereof; said anti-slip studs being evenly spread at the bottom side thereof; said Velcro fillet being securely sewn around the marginal rim thereof; said flexible frame being disposed between the sole layer marginal rim and Velcro fillet.

2. The “improved treading mat for vehicle internal floor” as recited in the claim 1, wherein, said elastic shag of the mat body and said sole layer are made of polyvinyl chloride (PVC) material.

3. The “improved treading mat for vehicle internal floor” as recited in the claim 1, wherein, said (meshed network) of the mat body is made of polyvinyl chloride (PVC) blending with dioctyl phthalate (DOP).

4. The “improved treading mat for vehicle internal floor” as recited in the claim 1, wherein, said flexible frame is made of steel wire.
